(19) United States
(12) Patent Application Publication
(10) Pub. No.: US 2022/0212651 A1
(43) Pub. Date: Jul. 7, 2022

(54) HYBRID VEHICLE OPERATION

(71) Applicant: FORD GLOBAL TECHNOLOGIES, LLC, Dearborn, MI (US)

(72) Inventors: Mark Anthony Tascillo, Canton, MI (US); Walter Joseph Ortmann, Saline, MI (US); Ashish Kumar NAIDU, Canton, MI (US); James Patrick Somsel, Tecumseh, MI (US)

(73) Assignee: FORD GLOBAL TECHNOLOGIES, LLC, Dearborn, MI (US)

(21) Appl. No.: 17/141,536

(22) Filed: Jan. 5, 2021

(51) Int. Cl. B60W 20/12

(52) U.S. Cl. CPC B60W 20/12; B60W 2555/60; B60W 2552/15; B60W 2520/30

(57) ABSTRACT

A powertrain control system includes a controller that, when attribute data is indicative of an expected deceleration having a magnitude that exceeds a threshold within a predefined duration of time after receipt of an engine on request, inhibits start of an engine, and when the attribute data is indicative of an expected deceleration having a magnitude that does not exceed the threshold within the predefined duration, permits start of the engine.

### TECHNICAL FIELD

The present disclosure relates to vehicle powertrain operation.

### BACKGROUND

In a hybrid electric vehicle, a controller may operate the vehicle between multiple propulsion modes including an electric only mode, an engine only mode, and a combination mode.

### SUMMARY

A vehicle includes an engine and a controller. The controller selectively turns off the engine based on attribute data such that when the attribute data is indicative of an expected torque or power demand exceeding a corresponding threshold within a predefined duration of time after receipt of an engine off request, the engine is not turned off, and when the attribute data is indicative of an expected torque or power demand not exceeding the corresponding threshold within the predefined duration of time, the engine is turned off.

A method includes responsive to attribute data being indicative of an expected torque or power demand exceeding a corresponding threshold within a predefined duration of time after receipt of an engine off request, inhibiting shut down of an engine, and responsive to the attribute data being indicative of an expected torque or power demand exceeding the corresponding threshold after the predefined duration of time, permitting shut down of the engine.

A powertrain control system includes a controller that, when attribute data is indicative of an expected deceleration having a magnitude that exceeds a threshold within a predefined duration of time after receipt of an engine on request, inhibits start of an engine, and when the attribute data is indicative of an expected deceleration having a magnitude that does not exceed the threshold within the predefined duration, permits start of the engine.

### BRIEF DESCRIPTION OF THE DRAWINGS

FIG. 1 is a diagram of an electrified vehicle illustrating drivetrain and energy storage components including an electric machine.

FIG. 2 is an example block topology of a vehicle system.

FIG. 3 is an example block diagram of the vehicle power control system.

FIG. 4 is an example flow diagram of a process for hybrid vehicle powertrain control.

FIGS. 5, 6, and 7 are example time graphs of hybrid vehicle powertrain control.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

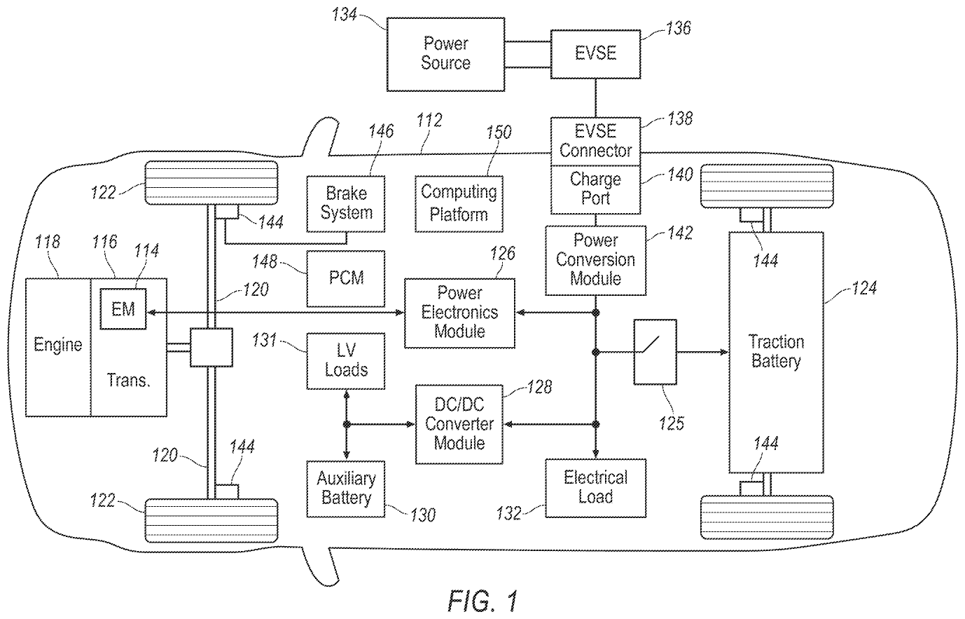

FIG. 1 depicts an electrified vehicle 112 that may be referred to as a plug-in hybrid-electric vehicle (PHEV), a battery electric vehicle (BEV), a mild hybrid-electric vehicle (MHEV), and/or full hybrid electric vehicle (FHEV). A plug-in hybrid-electric vehicle 112 may comprise one or more electric machines 114 mechanically coupled to a hybrid transmission 116. The electric machines 114 may be capable of operating as a motor or a generator. In addition, the hybrid transmission 116 is mechanically coupled to an engine 118. The hybrid transmission 116 is also mechanically coupled to a drive shaft 120 that is mechanically coupled to the wheels 122. The electric machines 114 can provide propulsion and braking capability when the engine 118 is turned on or off. The electric machines 114 may also act as generators and can provide fuel economy benefits by recovering energy that would normally be lost as heat in a friction braking system. The electric machines 114 may also reduce vehicle emissions by allowing the engine 118 to operate at more efficient speeds and allowing the hybrid-electric vehicle 112 to be operated in electric mode with the engine 118 off under certain conditions.

A traction battery or battery pack 124 may store energy that can be used by the electric machines 114. The vehicle battery pack 124 may provide a high voltage direct current (DC) output. The traction battery 124 may be electrically coupled to one or more power electronics modules 126 (such as a traction inverter). One or more contactors 125 may isolate the traction battery 124 from other components when opened and connect the traction battery 124 to other components when closed. The power electronics module 126 is also electrically coupled to the electric machines 114 and provides the ability to bi-directionally transfer energy between the traction battery 124 and the electric machines 114. For example, a traction battery 124 may provide a DC voltage while the electric machines 114 may operate with a three-phase alternating current (AC) to function. The power electronics module 126 may convert the DC voltage to a three-phase AC current to operate the electric machines 114. In a regenerative mode, the power electronics module 126 may convert the three-phase AC current from the electric machines 114 acting as generators to the DC voltage compatible with the traction battery 124.

The vehicle 112 may include a variable-voltage converter (VVC) (not shown) electrically coupled between the traction battery 124 and the power electronics module 126. The VVC may be a DC/DC boost converter configured to increase or boost the voltage provided by the traction battery 124. By increasing the voltage, current requirements may be decreased leading to a reduction in wiring size for the power electronics module 126 and the electric machines 114. Further, the electric machines 114 may be operated with better efficiency and lower losses.

In addition to providing energy for propulsion, the traction battery 124 may provide energy for other vehicle electrical systems. The vehicle 112 may include a DC/DC converter module 128 that converts the high voltage DC output of the traction battery 124 to a low voltage DC supply that is compatible with low-voltage vehicle loads. An output of the DC/DC converter module 128 may be electrically coupled to an auxiliary battery 130 (e.g., 12V battery) for charging the auxiliary battery 130. The low-voltage systems having one or more low-voltage loads 131 may be electrically coupled to the auxiliary battery 130. One or more electrical loads 132 may be coupled to the high-voltage bus/rail. The electrical loads 132 may have an associated controller that operates and controls the electrical loads 146 when appropriate. Examples of electrical loads 132 may be a fan, an electric heating element, and/or an air-conditioning compressor.

The electrified vehicle 112 may be configured to recharge the traction battery 124 from an external power source 134. The external power source 134 may be a connection to an electrical outlet. The external power source 134 may be electrically coupled to a charger or electric vehicle supply equipment (EVSE) 136. The external power source 134 may be an electrical power distribution network or grid as provided by an electric utility company. The EVSE 136 may provide circuitry and controls to regulate and manage the transfer of energy between the power source 134 and the vehicle 112. The external power source 134 may provide DC or AC electric power to the EVSE 136. The EVSE 136 may have a charge connector 138 for plugging into a charge port 140 of the vehicle 112. The charge port 140 may be any type of port configured to transfer power from the EVSE 136 to the vehicle 112. The charge port 140 may be electrically coupled to a charger or on-board power conversion module 142. The power conversion module 142 may condition the power supplied from the EVSE 136 to provide the proper voltage and current levels to the traction battery 124. The power conversion module 142 may interface with the EVSE 136 to coordinate the delivery of power to the vehicle 112. The EVSE connector 138 may have pins that mate with corresponding recesses of the charge port 140. Alternatively, various components described as being electrically coupled or connected may transfer power using a wireless inductive coupling.

One or more wheel brakes 144 may be provided for braking the vehicle 112 and preventing motion of the vehicle 112. The wheel brakes 144 may be hydraulically actuated, electrically actuated, or some combination thereof. The wheel brakes 144 may be a part of a brake system 146. The brake system 146 may include other components to operate the wheel brakes 144. For simplicity, the figure depicts a single connection between the brake system 146 and one of the wheel brakes 144. A connection between the brake system 146 and the other wheel brakes 144 is implied. The brake system 146 may include a controller to monitor and coordinate the brake system 146. The brake system 146 may monitor the brake components and control the wheel brakes 144 for slowing the vehicle. The brake system 146 may respond to driver commands and may also operate autonomously to implement features such as stability control. The controller of the brake system 150 may implement a method of applying a requested brake force when requested by another controller or sub-function.

The powertrain of the vehicle 112 may be operated and controlled via a powertrain control module (PCM) 148 connected to various components of the vehicle 112 via an in-vehicle network (to be described in detail below). The PCM 148 may be configured to perform various features. For instance, the PCM 148 may be configured to control the operations of the engine 118 and the electric machine 114 based on user input via an accelerator pedal (not shown) and a brake pedal (not shown). Responsive to receiving a user power demand via one or more pedals, the PCM 148 may distribute the power between the engine 118 and the electric machine 114 to satisfy the user demand. Under certain predefined conditions when less power/torque is demanded, the PCM 148 may disable the engine 118 and only rely on the electric machine 114 to provide power output to the vehicle 112. The PCM 148 may restart the engine 118 responsive to more power being needed. The PCM 148 may be further configured to perform power split between the electric machine 114 and the engine 118 using data received from other controllers of the vehicle 112 as coordinated by a computing platform 150.

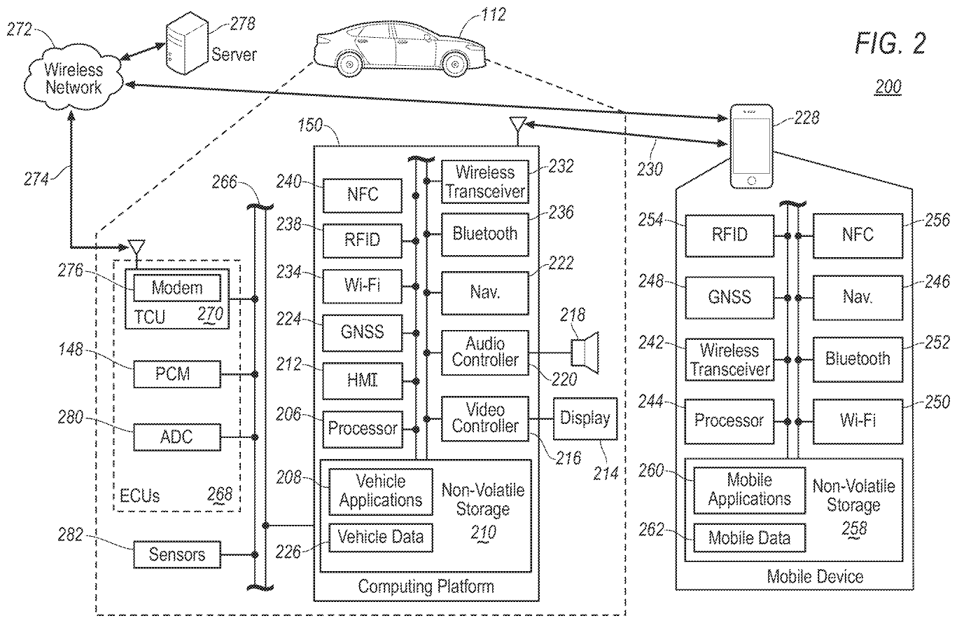

Referring to FIG. 2, an example block topology of a vehicle system 200 of one embodiment of the present disclosure is illustrated. As an example, the system 200 may include the SYNC system manufactured by The Ford Motor Company of Dearborn, Mich. It should be noted that the illustrated system 200 is merely an example, and more, fewer, and/or differently located elements may be used.

As illustrated in FIG. 2, the computing platform 150 may include one or more processors 206 configured to perform instructions, commands, and other routines in support of the processes described herein. For instance, the computing platform 150 may be configured to execute instructions of vehicle applications 208 to provide features such as navigation, remote controls, and wireless communications. Such instructions and other data may be maintained in a non-volatile manner using a variety of types of computer-readable storage medium 210. The computer-readable medium 210 (also referred to as a processor-readable medium or storage) includes any non-transitory medium (e.g., tangible medium) that participates in providing instructions or other data that may be read by the processor 206 of the computing platform 150. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The computing platform 150 may be provided with various features allowing the vehicle occupants/users to interface with the computing platform 150. For example, the computing platform 150 may receive input from HMI controls 212 configured to provide for occupant interaction with the vehicle 112. As an example, the computing platform 150 may interface with one or more buttons, switches, knobs, or other HMI controls configured to invoke functions on the computing platform 150 (e.g., steering wheel audio buttons, a push-to-talk button, instrument panel controls, etc.).

The computing platform 150 may also drive or otherwise communicate with one or more displays 214 configured to provide visual output to vehicle occupants by way of a video controller 216. In some cases, the display 214 may be a touch screen further configured to receive user touch input via the video controller 216, while in other cases the display 214 may be a display only, without touch input capabilities. The computing platform 150 may also drive or otherwise communicate with one or more speakers 218 configured to provide audio output and input to vehicle occupants by way of an audio controller 220.

The computing platform 150 may also be provided with navigation and route planning features through a navigation controller 222 configured to calculate navigation routes responsive to user input via, for example, the HMI controls 212, and output planned routes and instructions via the speaker 218 and the display 214. Location data that is needed for navigation may be collected from a global navigation satellite system (GNSS) controller 224 configured to communicate with multiple satellites and calculate the location of the vehicle 112. The GNSS controller 224 may be configured to support various current and/or future global or regional location systems such as global positioning system (GPS), Galileo, Beidou, Global Navigation Satellite System (GLONASS) and the like. Map data used for route planning may be stored in the storage 210 as a part of the vehicle data 226. Navigation software may be stored in the storage 210 as one the vehicle applications 208.

The computing platform 150 may be configured to wirelessly communicate with a mobile device 228 of the vehicle users/occupants via a wireless connection 230. The mobile device 228 may be any of various types of portable computing devices, such as cellular phones, tablet computers, wearable devices, smart watches, smart fobs, laptop computers, portable music players, or other devices capable of communication with the computing platform 150. A wireless transceiver 232 may be in communication with a Wi-Fi controller 234, a Bluetooth controller 236, a radio-frequency identification (RFID) controller 238, a near-field communication (NFC) controller 240, and other controllers such as a Zigbee transceiver, an IrDA transceiver, a ultra-wide band (UWB) controller (not shown), and be configured to communicate with a compatible wireless transceiver 242 of the mobile device 228.

The mobile device 228 may be provided with a processor 244 configured to perform instructions, commands, and other routines in support of the processes such as navigation, telephone, wireless communication, and multi-media processing. For instance, the mobile device 228 may be provided with location and navigation functions via a navigation controller 246 and a GNSS controller 248. The mobile device 228 may be provided with the wireless transceiver 242 in communication with a Wi-Fi controller 250, a Bluetooth controller 252, a RFID controller 254, an NFC controller 256, and other controllers (not shown), configured to communicate with the wireless transceiver 232 of the computing platform 150. The mobile device 228 may be further provided with a non-volatile storage 258 to store various mobile application 260 and mobile data 262.

The computing platform 150 may be further configured to communicate with various components of the vehicle 112 via one or more in-vehicle networks 266. The in-vehicle network 266 may include, but is not limited to, one or more of a controller area network (CAN), an Ethernet network, and a media-oriented system transport (MOST), as some examples. Furthermore, the in-vehicle network 266, or portions of the in-vehicle network 266, may be a wireless network accomplished via Bluetooth low-energy (BLE), Wi-Fi, UWB, or the like.

The computing platform 150 may be configured to communicate with various electronic control units (ECUs) 268 of the vehicle 112 configured to perform various operations. As discussed above, the computing platform 150 may be configured to communicate with the PCM 148 via the in-vehicle network 266. The computing platform 150 may be further configured to communicate with a TCU 270 configured to control telecommunication between vehicle 112 and a wireless network 272 through a wireless connection 274 using a modem 276. The wireless connection 274 may be in the form of various communication networks, for example, a cellular network. Through the wireless network 272, the vehicle may access one or more servers 278 to access various content for various purposes. It is noted that the terms wireless network and server are used as general terms in the present disclosure and may include any computing network involving carriers, router, computers, controllers, circuitry or the like configured to store data and perform data processing functions and facilitate communication between various entities. The ECUs 268 may further include an autonomous driving controller (ADC) 280 configured to control an autonomous driving feature of the vehicle 112. Driving instructions may be received remotely from the server 278. The ADC 280 may be configured to perform the autonomous driving features using the driving instructions combined with navigation instructions from the navigation controller 222. The ECUs 268 may be provided with or connected to one or more sensors 282 providing signals related to the operation of the specific ECU 268. For instance, the sensors 282 may include an ambient temperature sensor configured to measure the ambient temperature of the vehicle 112. The sensors 282 may further include one or more engine/coolant temperature sensors configured to measure the temperature of the engine/coolant and provide such data to the PCM 148. The sensors 282 may further include a camera configured to capture an image near the vehicle to enable various features such as autonomous driving features via the ADC 280.

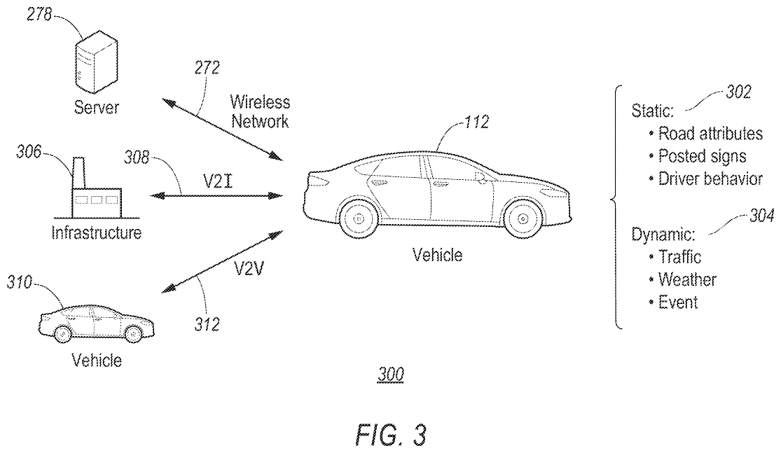

The PCM 148 may be configured to operate the vehicle powertrain based on data received from various sources. Referring to FIG. 3, an example diagram 300 of the vehicle drivetrain control system is illustrated. In general, the data used by the PCM 148 may be classified into one of a static attribute 302 and a dynamic attribute 304 received from various sources. The static attribute 302 may reflect characteristics of a route on which the vehicle 112 traverses that does not vary over time. As a few non-limiting examples, the static attribute 302 may include various road attributes of the route such as number of lanes, speed limit, road pavement condition, road grade or the like. The static attribute 302 may further include road signs posted near or on the vehicle route. The static attribute 302 may further include one or more driver behavior attributes (driving pattern) of a vehicle user which records a pattern/habit of driving of the user operating the vehicle. The driver behavior may be previously recorded by the vehicle 112. Alternatively, the driver behavior may be identified or received from a digital entity associated with the vehicle driver (such as the mobile device 228). The driver behavior attribute may reflect driving patterns of one or more drivers operating the vehicle. For instance, some drivers are more aggressive and drive faster by applying the accelerator pedal harder. The driver behavior attribute may affect the vehicle power and/or torque demand and driving speed. In some cases, the PCM 148 may use the driver behavior attribute to determine if the vehicle 112 can pass an intersection before the traffic light turns red as an example.

The dynamic attribute may reflect characteristics of the route that may vary over time. As a few non-limiting examples, the dynamic attribute 304 may include traffic and weather conditions on the route which may affect the operation of the vehicle 112. The dynamic attribute 304 may further include road events such as accident and road work on the route. As an example, live traffic data and traffic signal timings may be sent to the vehicle 112. Coupled with the static attributes 302, the PCM 148 of the vehicle 112 may predict a motion pattern reflecting the time and location to accelerate, decelerate and stop on the vehicle route, so that the hybrid powertrain may be calibrated more accurately.

The vehicle 112 may be configured to obtain the static and dynamic attributes 302, 304 from a variety of sources. For instance, the vehicle 112 may obtain the attributes from one or more cloud servers 278 via the wireless network 272 through the TCU 270. Additionally or alternatively, the vehicle 112 may be configured to access the servers 278 via the mobile device 228 associated with the vehicle user. The vehicle 112 may be further configured to communicate with an infrastructure device 306 via a vehicle-to-infrastructure (V2I) link to obtain the attributes. The infrastructure 306 may include sensor and communication devices along the vehicle route to provide driving information to the vehicle 112. For instance, the infrastructure device 306 may include a smart traffic light transmitting signals indicating the status and timing of the traffic signal to vehicles nearby. The vehicle 112 may be further configured to communicate with one or more fleet vehicles 310 provided with compatible transceivers via a vehicle-to-vehicle (V2V) link 312. For instance, the fleet vehicle 310 may detect an attribute via a fleet vehicle sensor and share the attribute to the vehicle 112. The wireless network 272, the V2I link 308 and the V2V link 312 may be collectively referred to as a vehicle-to-everything (V2X) connection. Additionally, the vehicle 112 may be configured to obtain the attributes via one or more sensors 282.

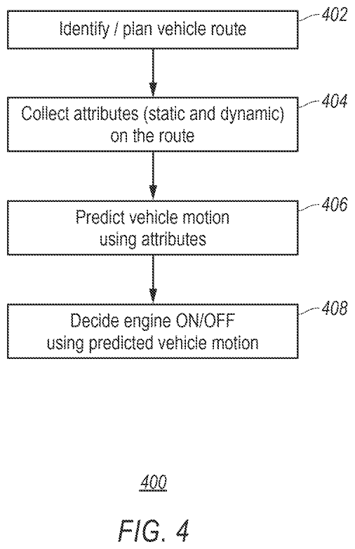

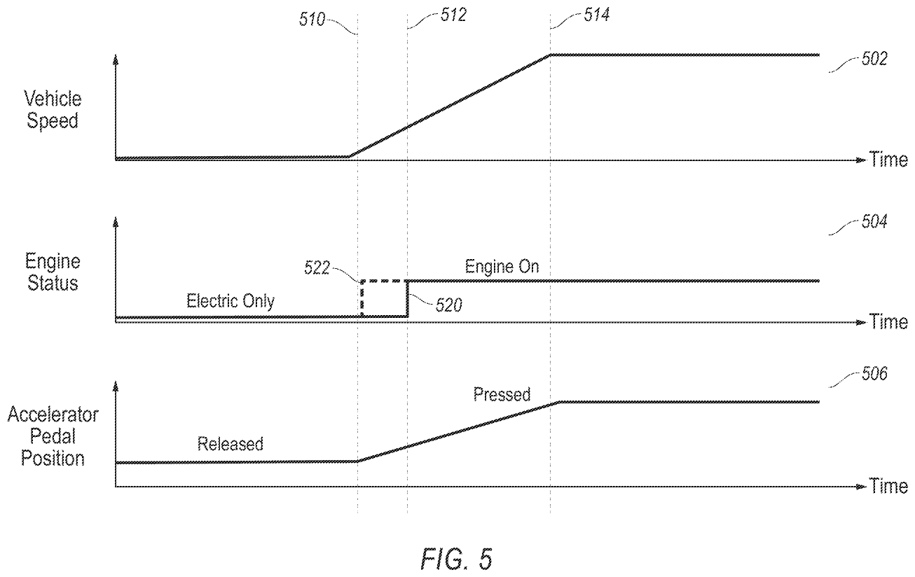

Referring to FIG. 4, an example flow diagram of a process 400 for a hybrid vehicle powertrain control is illustrated. With continuing reference to FIGS. 1-3, the process 400 may be performed via one or more controllers/platforms of the vehicle 112. For simplicity purposes, the following description will be primary made with regard to PCM 148 although the process 400 may be performed by other controllers in lieu of or in combination with the PCM 148. The process 400 may be applied to any type of hybrid vehicle propelled by an electric machine 114 powered by electricity and another motor/engine 118 powered by a type of energy source other than electricity (e.g., gasoline, diesel, natural gas, hydrogen or the like). At operation 402, the vehicle 112 identifies or plans a route responsive to a user starting to use the vehicle 112. The route may be planned using the navigation software 208 via the navigation controller 222 responsive to a destination input by a user. Alternatively, the computing platform 150 and the navigation controller 222 may automatically identify a predicted route using the current location and/or historical route of the vehicle 112 in the absence of the navigation destination input by the user. Having the vehicle route available, at operation 404, the vehicle 112 collects both the static and dynamic attributes 302, 304 along the route from various sources as described above with reference to FIG. 3. At operation 406, the vehicle 112 predicts a vehicle motion pattern along the planned route using the attributes collected. The motion pattern may include a predicted vehicle speed at different sections of the route. For instance, the traffic attribute 304 may reflect a traffic flow and timing of a plurality of traffic lights on the vehicle route. The vehicle 112 may use the traffic flow data, combined with the driver behavior and other attributes, to predict the torque demand of the vehicle 112 at a given point on the route. The vehicle 112 may further predict the status of each traffic light when the vehicle 112 arrives, so as to determine if the vehicle 112 needs to stop or slow down at a red light, or to drive by without stopping when the light is green for example. At operation 408 the PCM 148 decides the operating status of the engine 118 using the predicted vehicle motion pattern. The details of operation 408 will be described with references to the examples illustrated in FIGS. 5-7 below.

Referring to FIG. 5, example time graphs of the hybrid vehicle powertrain control of one embodiment are illustrated. With continuing reference to FIGS. 1-4, a first time graph 502 illustrates the speed of the vehicle 112 over time. A second time graph 504 illustrates the operation mode of the vehicle engine 118 (i.e., ON/OFF). A third time graph 506 illustrates an accelerator pedal position of the vehicle 112. Referring to the time graphs, in the present example, the vehicle 112 starts to accelerate at time 510 as the accelerator pedal is gradually depressed. Based on the motion pattern as predicted at operation 406 illustrated in FIG. 4, the acceleration may be a long process beyond a predefined acceleration threshold until time 514 in the present example. Conventionally, the PCM 148 may not start the vehicle engine 118 until the acceleration has started for a period of time (e.g., at time 512 as illustrated by solid line 520 in the second time graph 504 in the present example) once the PCM 148 determines the acceleration continues and extra power and torque is needed from the engine 118. Here, since the motion pattern that has been calculated in advance suggests the acceleration lasts longer than a predefined threshold, the PCM 148 may turn on the engine 118 earlier as illustrated in the dashed line 522 in the second paragraph to provide the extra power and torque to facilitate the long acceleration, which may in turn improve the performance of the vehicle as well as the user experience. The threshold to be used by the PCM 148 to decide whether an early engine start is needed may be any one of a time threshold (e.g., 5 seconds), a distance threshold (e.g., 200 meters), or a power and/or torque threshold.

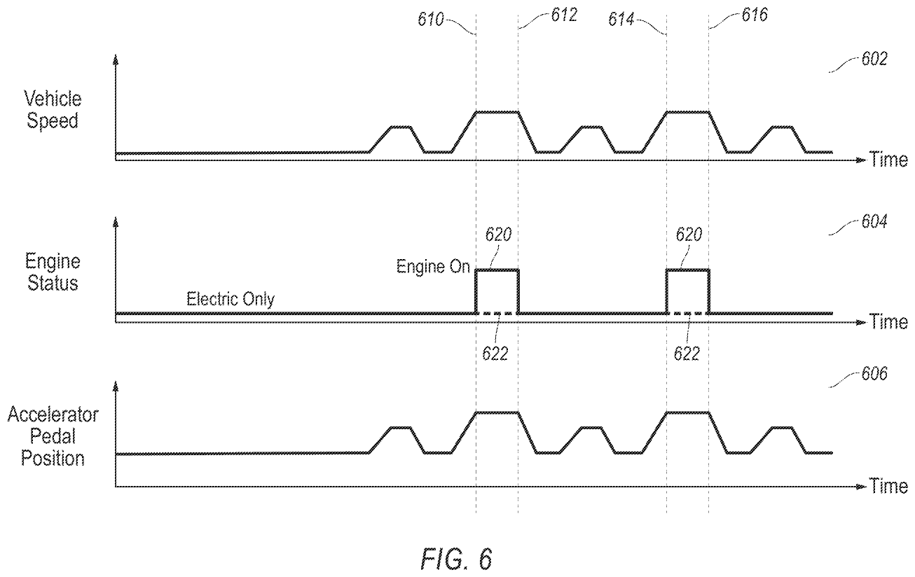

Referring to FIG. 6, example time graphs of the hybrid vehicle powertrain control of another embodiment are illustrated. Similar to FIG. 5, three time graphs are illustrated in FIG. 6. A first time graph 602 illustrates the speed of the vehicle 112 over time. A second time graph 604 illustrates the operation mode of the vehicle engine 118. A third time graph 606 illustrates an accelerator pedal position of the vehicle 112. As an example, FIG. 6 may be applied to a stop and go traffic situation. In the present example, the PCM 148 mostly operates the vehicle 112 in the electric only mode. Under the conventional approach, the engine 118 may be arbitrarily turned on at time 610 and 614 responsive to an acceleration, and turned off at time 614 and 616 shortly after responsive to a deceleration as illustrated in the solid line 620. However, since the decelerations shortly after the acceleration within a predefined time threshold may be predicted in the motion pattern, the PCM 148 may reframe from turning on the engine 118 in response to the accelerations and operate in the electric only mode to increase the efficiency of the vehicle 112 and provide an improved user experience.

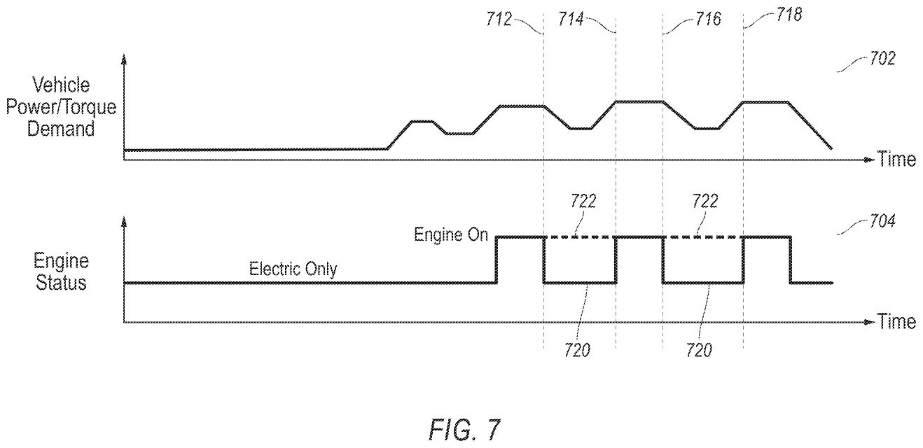

Referring to FIG. 7, example time graphs of the hybrid vehicle powertrain control of yet another embodiment are illustrated. A first time graph 702 illustrates the power and/or torque demand of the vehicle 112 over time. A second time graph 604 illustrates the operation mode of the vehicle engine 118. As an example, FIG. 6 may be applied to a large parking lot and parking garage situation where high power and/or torque demand is present (e.g., due to the ramps). As illustrated in the second time graph 504, under the conventional approach without the attribute analysis, the PCM 148 may repeatedly turn the engine on and off within a short time frame. More specifically as illustrated in the solid line 720, the PCM 148 may turn off the engine 118 at time 712 responsive to a reduced power/torque demand and turn the engine 118 back on responsive to an increased power torque demand at time 714. The process repeats as the PCM 148 turns off the engine 118 responsive to another reduced power/torque demand at time 716 and turn on the engine 118 responsive to another increased power/torque demand at time 718. With the motion pattern predicted, the PCM 148 inhibits turning off the engine 118 and keeps the engine 118 running responsive to the increased power/torque demand as predicted and illustrated in dashed line 722. Here, one or more thresholds may be used by the PCM 148 to decide whether to inhibit the engine turn off. For instance, the PCM 148 may be configured to inhibit the engine turn off responsive to a torque demand above a torque threshold being anticipated to be within a time threshold from the turn off condition being met. The PCM 148 may be further configured to adjust one or more thresholds to accommodate the specific design needs. Continuing with the above example illustrated in FIG. 7, a greater torque threshold may be used responsive to a longer time between the conventional engine turn off command and the power/torque being anticipated (e.g. time between 712 and 714, and time between 716 and 718 on time graph 704).

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as Read Only Memory (ROM) devices and information alterably stored on writeable storage media such as floppy disks, magnetic tapes, Compact Discs (CDs), Random Access Memory (RAM) devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure.

As previously described, the features of various embodiments can be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle comprising:
an engine; and
a controller programmed to selectively turn off the engine based on attribute data such that when the attribute data is indicative of an expected torque or power demand exceeding a corresponding threshold within a predefined duration of time after receipt of an engine off request, the engine is not turned off, and when the attribute data is indicative of an expected torque or power demand not exceeding the corresponding threshold within the predefined duration of time, the engine is turned off.

2. The vehicle of claim 1, wherein the controller is further programmed to selectively turn off the engine based on the attribute data such that when the attribute data is indicative of an expected torque or power demand exceeding the corresponding threshold after the predefined duration of time, the engine is turned off.

3. The vehicle of claim 1, wherein the controller is further programmed to set a value of the corresponding threshold according to a time between the receipt of the engine off request and a predicted occurrence of the expected torque or power demand such that the greater the time, the greater the value.

4. The vehicle of claim 1, wherein the controller is further programmed to, when the attribute data is indicative of an expected acceleration greater than an acceleration threshold while the engine is off, start the engine.

5. The vehicle of claim 1, wherein the attribute data include traffic conditions and route signal timing.

6. The vehicle of claim 1, wherein the attribute data include road grade and speed limit.

7. A method comprising:
responsive to attribute data being indicative of an expected torque or power demand exceeding a corresponding threshold within a predefined duration of time after receipt of an engine off request, inhibiting shut down of an engine; and
responsive to the attribute data being indicative of an expected torque or power demand exceeding the corresponding threshold after the predefined duration of time, permitting shut down of the engine.

8. The method of claim 7 further comprising, responsive to the attribute data being indicative of an expected torque or power demand not exceeding the corresponding threshold within the predefined duration of time, permitting shut down of the engine.

9. The method of claim 7 further comprising setting a value of the corresponding threshold according to a time between the receipt of the engine off request and a predicted occurrence of the expected torque or power demand such that the greater the time, the greater the value.

10. The method of claim 7 further comprising, responsive to the attribute data being indicative of an expected acceleration greater than an acceleration threshold while the engine is off, start the engine.

11. The method of claim 7, wherein the attribute data include traffic conditions and route signal timing.

12. The method of claim 7, wherein the attribute data include road grade and speed limit.

13. A powertrain control system comprising:
a controller programmed to, when attribute data is indicative of an expected deceleration having a magnitude that exceeds a threshold within a predefined duration of time after receipt of an engine on request, inhibit start of an engine, and when the attribute data is indicative of an expected deceleration having a magnitude that does not exceed the threshold within the predefined duration, permit start of the engine.

14. The powertrain control system of claim 13, wherein the controller is further programmed to, when the attribute data is indicative of an expected deceleration having a magnitude that exceeds the threshold after the predefined duration of time, permit start of the engine.

15. The powertrain control system of claim 13, wherein the controller is further programmed to set a value of the threshold according to a time between the receipt of the engine on request and a predicted occurrence of the expected deceleration such that the greater the time, the greater the value.

16. The powertrain control system of claim 13, wherein the attribute data include traffic conditions and route signal timing.

17. The powertrain control system of claim 13, wherein the attribute data include road grade and speed limit.
